(19) United States
(12) Patent Application Publication
(10) Pub. No.: US 2025/0308499 A1
(43) Pub. Date: Oct. 2, 2025

(54) ACTIVE VIBRATION NOISE CONTROL DEVICE

(71) Applicant: HONDA MOTOR CO., LTD., Tokyo (JP)

(72) Inventors: Xun WANG, Wako-shi (JP); Takuma MAESAKA, Wako-shi (JP); Toshio INOUE, Wako-shi (JP)

(21) Appl. No.: 19/062,901

(22) Filed: Feb. 25, 2025

(30) Foreign Application Priority Data
Mar. 29, 2024 (JP) 2024-058280

(51) Int. Cl. G10K 11/178

(52) U.S. Cl. CPC G10K 11/17815; G10K 11/17823; G10K 11/17825; G10K 11/17881; G10K 2210/12821; G10K 2210/129; G10K 2210/3018; G10K 2210/3026; G10K 2210/3027; G10K 2210/3028

(57) ABSTRACT

An active vibration noise control device includes: a speaker for outputting a cancellation sound for canceling a noise; an error microphone for generating an error signal from the noise and the cancellation sound; a control filter configured to generate the cancellation sound based on a plurality of reference signals corresponding to the noise; and a disturbance determination part configured to make a determination as to whether a disturbance is present using the error signal and the plurality of reference signals. The disturbance determination part is configured to: calculate an overall correlation by summing a correlation function between each of the plurality of reference signals and the error signal, and make the determination as to whether the disturbance is present based on the overall correlation.

### CROSS REFERENCE TO RELATED APPLICATIONS

This application claims foreign priority to Japanese Patent Application No. 2024-058280, filed Mar. 29, 2024, the disclosure of which is incorporated herein by reference in its entirety.

### TECHNICAL FIELD

The present invention relates to an active vibration noise control device.

### BACKGROUND ART

A conventional active vibration noise control device includes a cancellation sound output device that outputs a cancellation sound for canceling noise, a noise signal generation device that generates a noise signal based on the noise, and a control device that controls the cancellation sound output device based on the noise signal.

The control device acquires buffer data in which noise signals are accumulated in time series, generates a plurality of divided data by dividing the buffer data, and calculates a correlation value of the buffer data based on the plurality of divided data. Then, the control device detects whether disturbance is mixed in the buffer data based on the correlation value and switches control for the cancellation sound output device based on whether a disturbance mixed in the buffer data is present (see, for example, Japanese Patent Application Laid-Open No. 2023-144502).

### SUMMARY OF THE INVENTION

### Problems to be Solved by the Invention

Incidentally, there are cases where periodic noise components are small (for example, no engine sound is present in a case of an electric vehicle or in the electric traveling mode of a hybrid vehicle). In such a case, the road noise and the aerodynamic noise are dominant, so that the indoor noise is a sound having strong randomness, and thus the autocorrelation is naturally small.

Due to this, even when the mixing of disturbance is to be determined by the decrease of the correlation value as in the conventional active vibration noise control device, the determination may not be accurate.

Therefore, it is difficult for the conventional technique to control the on/off or increase/decrease of the cancellation sound for reducing the indoor noise based on whether a disturbance is present. Further, there is a possibility that noise is amplified, so that the noise reduction effect is not stable. Therefore, further improvement is required.

It is an object of this disclosure to provide an active vibration noise control device capable of stably reducing noise by accurately detecting the mixing of a disturbance even when periodic noise components are small.

### Solution to Problems

In order to solve the above-described problem, an aspect of the present invention is an active vibration noise control device including: a speaker for outputting a cancellation sound for canceling a noise; an error microphone for generating an error signal from the noise and the cancellation sound; a control filter configured to generate the cancellation sound based on a plurality of reference signals corresponding to the noise; and a disturbance determination part configured to make a determination as to whether a disturbance is present using the error signal and the plurality of reference signals, wherein the disturbance determination part is configured to: calculate an overall correlation by summing a correlation function between each of the plurality of reference signals and the error signal, and make the determination as to whether the disturbance is present based on the overall correlation.

### Effects of the Invention

The present invention provides an active vibration noise control device capable of accurately detecting the mixing of a disturbance and stably reducing the noise even when the periodic noise components are small.

### BRIEF DESCRIPTION OF THE DRAWINGS

FIG. 1 is a schematic side view illustrating the configuration of a vehicle to which an active vibration noise control device of a first embodiment is applied.

FIG. 2 is a schematic plan view of the vehicle to which the active vibration noise control device of the first embodiment is applied.

FIG. 3 is a block diagram for explaining the function of the active vibration noise control device of the first embodiment with reference to one error microphone.

FIG. 4 is a block diagram illustrating a configuration with a plurality of error microphones in the active vibration noise control device of the first embodiment.

FIG. 5 is a flowchart illustrating a control process performed by a disturbance determination part according to the first embodiment.

FIG. 6 is a flowchart illustrating a control process performed by the disturbance determination part based on the air volume of an air conditioner.

FIG. 7 is a flowchart illustrating a control process performed by the disturbance determination part based on an open/close state of a window.

FIG. 8 is a block diagram illustrating a configuration of an active vibration noise control device according to a second embodiment, which is based on the first embodiment with an additional reference microphone.

FIG. 9 is a flowchart illustrating a process of using a result of determination as to whether a disturbance is present for control of a control filter in the active vibration noise control device according to the second embodiment.

### DETAILED DESCRIPTION OF EMBODIMENT

Hereinafter, embodiments of the present invention will be described with reference to the drawings as appropriate. The same components are denoted by the same reference signs, and duplicated description will be omitted. In the present specification, (hat) written together with various symbols indicates an identified value or an estimation value.

### First Embodiment

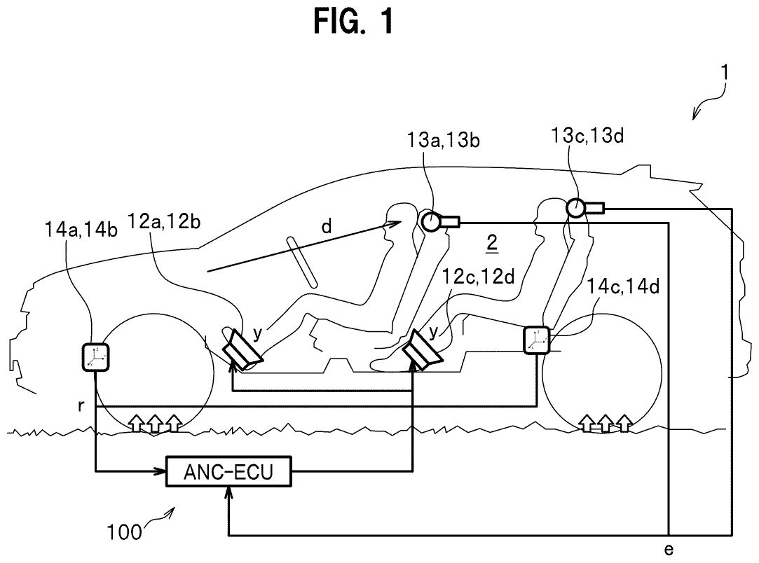

FIG. 1 shows a vehicle 1 to which an active vibration noise control device (hereinafter, also abbreviated as “noise control device” or “ANC-ECU”) 100 according to a first embodiment is applied. In the description of the vehicle 1, the same elements are denoted by the same reference signs, and duplicated description will be omitted. In addition, when directions are described, the description is based on front-rear, left-right, and up-down (xyz) as viewed from the driver of the vehicle 1. Note that the vehicle width direction and the left-right direction are synonymous.

The noise control device 100 is an active noise control (ANC) device for reducing noise d generated in the vehicle compartment 2 of the vehicle 1. More specifically, the noise control device 100 generates a cancellation sound y having a phase opposite to that of the noise d to cause the generated cancellation sound y to interfere with the noise d. With this, the noise control device 100 can reduce the noise d to be reduced.

For example, the noise d to be reduced by the noise control device 100 is a road noise caused by wheel vibration due to forces from a road surface. Note that the noise d to be reduced by the noise control device 100 may be a noise other than the road noise (e.g., wind noise or drive system noise caused by vibration of a drive source such as an internal combustion engine or an electric motor).

The noise control device 100 of the first embodiment illustrated in FIG. 1 includes a plurality of speakers 12a to 12d that output cancellation sounds y for canceling the noise d. The noise control device 100 further includes a plurality of error microphones 13a to 13d that generate error signals e from the noise d and the cancellation sounds y.

The noise control device 100 of the first embodiment includes a plurality of acceleration sensors 14a to 14d. In the first embodiment, a total of four acceleration sensors 14a to 14d are provided for the four wheels, one for each of the front, rear, left, and right wheels of the vehicle 1. The acceleration sensors 14a to 14d are each configured to detect accelerations in three axial directions, i.e., front-rear, left-right, and up-down (xyz) directions, and are configured to generate reference signals r1 to rN representing vibrations transmitted to the vehicle body due to a contact which is made between the road surface and the wheels and is a source of the road noise.

The reference signals r1 to IN obtained from the acceleration sensors 14a to 14d have vibrations applied in the xyz directions to the vehicle body from the wheels as major components. The reference signals r1 to rN do not include components of disturbance factors such as a sound of the wind of an air conditioner provided in the vehicle 1 and a sound of the wind entering the vehicle compartment 2 due to a window being opened.

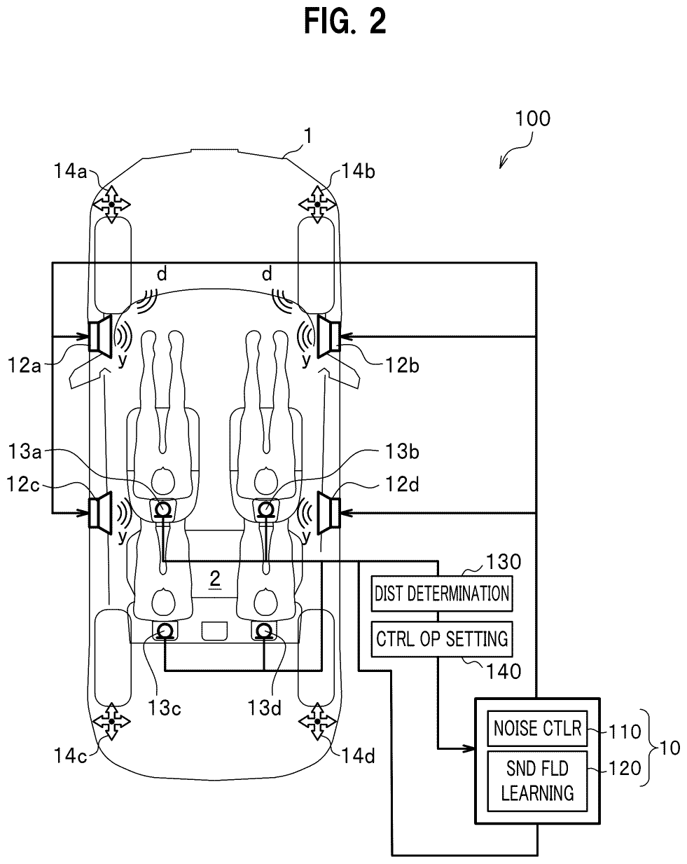

As illustrated in FIG. 2, the noise control device 100 includes a control filter part 10 that generates cancellation sounds from the reference signals, a disturbance determination part 130, and a control operation setting part 140. The reference signals r1 to rN, generated by the acceleration sensors 14a to 14d, are transmitted to the control filter part 10 and the disturbance determination part 130.

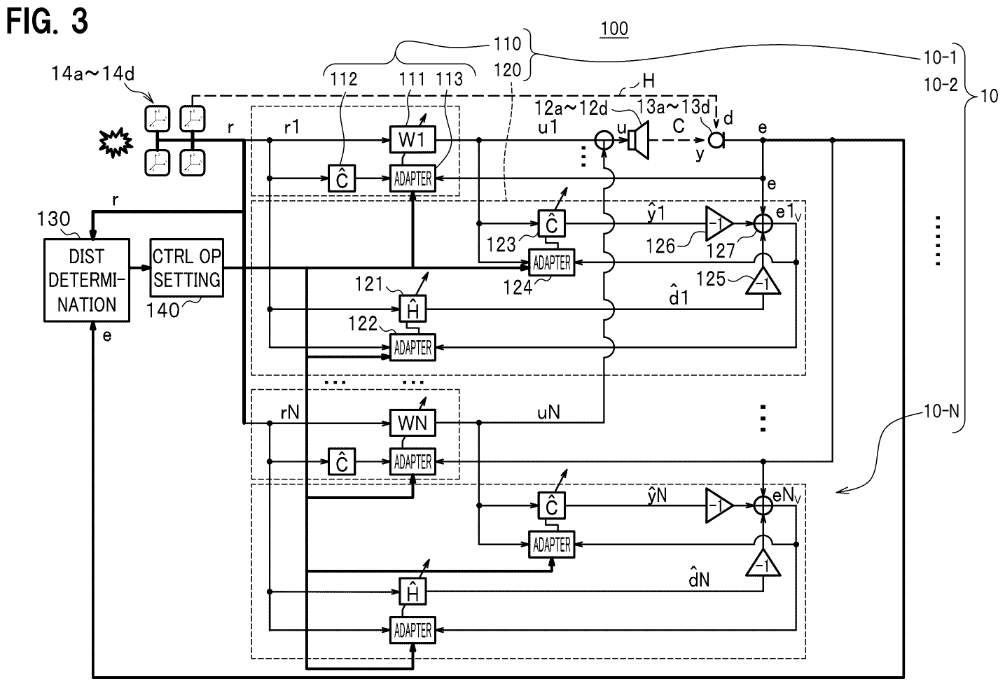

As illustrated in FIG. 3, the control filter part 10 of the first embodiment is provided for each of the microphones 13a to 13d and each control filter part 10 includes a plurality of control filters 10-1 to 10-N for the N (=3 directions×4 wheels=12) channel reference signals r1 to rN generated from the acceleration sensors 14a to 14d.

Here, a description will be given with reference to one control filter 10-1 included in the control filter part 10 of the present embodiment. The other control filters 10-2 to 10-N are each configured to function in a manner similar to the control filter 10-1, and thus the description thereof will be omitted.

As illustrated in FIG. 3, the control filter 10-1 includes a noise controller 110 and a sound field learning part 120. The noise controller 110 and the sound field learning part 120 are implemented by, for example, a computer including an arithmetic processing device (a processor such as a central processing unit (CPU) or a micro processing unit (MPU)) and a storage device (a memory such as a read only memory (ROM) and a random access memory (RAM)).

Note that, in the noise control device 100, the noise controllers 110, the sound field learning parts 120, and the disturbance determination part 130 and the control operation setting part 140, which will be described later, other than the speakers 12a to 12d, the error microphones 13a to 13d, and the acceleration sensors 14a to 14d, may be configured as a single piece of hardware or a unit including a plurality of pieces of hardware.

The noise controller 110 includes a first filter 111, a secondary path filter part 112, and a control updater 113.

The noise controller 110 receives a respective one of the reference signals r1 to rN corresponding to the noise d and transmitted from the acceleration sensors 14a to 14d.

Each of the reference signals r1 to r12 generated by the acceleration sensors 14a to 14d of the first embodiment has vibration components applied to the vehicle body from a corresponding one of the four wheels as major components. Note that the reference signals r1 to r12 contain almost no components that act as disturbance factors, such as a sound of the wind from the air conditioner or a sound of the wind entering the vehicle compartment 2 due to a window being opened.

The first filters 111 of the first embodiment generate control signals u1 to uN respectively from the reference signals r1 to rN.

The first filters 111 of the first embodiment each may be composed of a finite impulse response (FIR) filter, for example. An FIR filter is a kind of digital filter and is a filter with an impulse response whose continuation duration is finite. In other words, an FIR filter is a filter such that the output signal (impulse response) output when an impulse signal is input converges within a finite time.

The first filters 111 transmit the control signals u1 to uN to a corresponding one of the speakers 12a to 12d. More in detail, an adder adds the control signals u1 to uN to generate a control signal u, which is transmitted to the corresponding one of the speakers 12a to 12d. Each of the speakers 12a to 12d outputs a cancellation sound y using the input control signal u.

The secondary path filter part 112 is composed of a secondary path filter having a filter characteristic C. The secondary path filter corresponds to a estimation value of the transfer characteristic C of a cancellation sound y from a corresponding one of the speakers 12a to 12d to a corresponding one of the error microphones 13a to 13d. The secondary path filter may be an FIR filter or a Single Frequency Adaptive Notch (SAN) filter which is a single-tap adaptive filter specialized for periodic noise.

Moreover, the control updater 113 adaptively updates the filter characteristic W of the first filter 111 using an adaptive algorithm such as a least mean square (LMS) algorithm.

The control updater 113 receives: a reference signal obtained by passing a corresponding one of the reference signals r1 to rN from the acceleration sensors 14a to 14d through the secondary path filter part 112; and the error signal e generated by a corresponding one of the error microphones 13a to 13d.

The control updater 113 adaptively updates the filter characteristic of the first filter 111, i.e., a corresponding one of the filter characteristics W1 to WN, so that the error signal e is minimized by the cancellation sound y.

Thus, the first filter 111 of each noise controller 110 performs filtering on a respective one of the reference signals r1 to rN with a respective one of the adaptively updated filter characteristics W1 to WN. Each first filter 111 generates a respective one of the control signals u1 to uN for controlling the output of a corresponding one of the speakers 12a to 12d. The sound field learning parts 120 of the noise control device 100 each receive a respective one of the reference signals r1 to rN transmitted from the acceleration sensors 14a to 14d.

Each sound field learning part 120 includes, for the channel of the respective reference signal: a primary path filter part 121 with a filter characteristic Ĥ; and a primary path updater 122. The primary path filter part 121 and the primary path updater 122 of each sound field learning part 120 receive the respective one of the reference signals r1 to rN.

Each sound field learning part 120 includes a secondary path filter part 123 with the filter characteristic Ĉ and a secondary path updater 124. The secondary path filter part 123 and the secondary path updater 124 of each sound field learning part 120 receive a respective one of the control signals u1 to uN generated by the respective first filter 111.

Each sound field learning part 120 includes a first polarity inverter 125, a second polarity inverter 126, and an adder 127. The first polarity inverter 125 inverts the polarity of a respective one of the noise signals \hat{d}1 to \hat{d}N, generated by the primary path filter part 121, and sends the inverted noise signal to the adder 127.

The second polarity inverter 126 inverts the polarity of a respective one of the cancellation sound signal ŷ1 to ŷN, generated by the secondary path filter part 123, and sends the inverted cancellation sound signal to the adder 127.

The adder 127 adds the noise signal d with inverted polarity, the cancellation sound signal ý with inverted polarity, and the error signal e generated by a corresponding one of the error microphones 13a to 13d to obtain a respective one of the error signals e1 to eN. Each of the error signals e1 to eN is sent to the respective primary path updater 122 and the respective secondary path updater 124 and is used for adaptive updating of the respective primary path filter part 121 and the respective secondary path filter part 123.

Note that, when the secondary path updater 124 adaptively updates the filter characteristic C of the secondary path filter part 123, the secondary path updater 124 updates the filter characteristic C of the secondary path filter part 112 to be the same as the filter characteristic C of the secondary path filter part 123.

The disturbance determination part 130 receives the reference signals r1 to rN transmitted from the acceleration sensors 14a to 14d and the error signals e transmitted from the error microphones 13a to 13d.

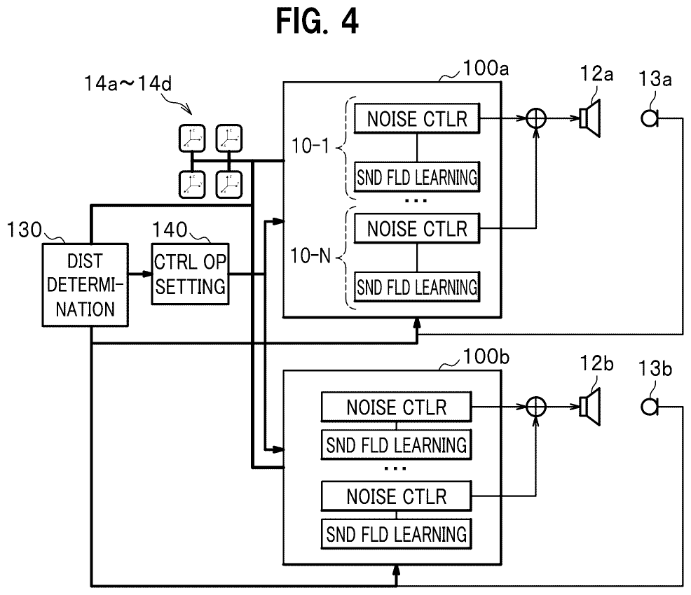

For example, in the first embodiment, as illustrated in FIG. 4, noise control devices 100a, 100b, . . . configured similarly to the noise control device 100 illustrated in FIG. 3 are provided for the plurality of error microphones 13a, 13b, . . . , respectively.

The noise control devices 100a and 100b are each connected to the acceleration sensors 14a to 14d, the disturbance determination part 130, and the control operation setting part 140. The noise control devices 100a and 100b are connected to the speakers 12a and 12b, respectively.

Note that, in FIG. 4, illustration of the error microphones 13c and 13d and the noise control devices corresponding to the error microphones 13c and 13d is omitted. These noise control devices are also each connected to the acceleration sensors 14a to 14d, the disturbance determination part 130, the control operation setting part 140, and the speakers 12c and 12d, as in the noise control devices 100a and 100b (see FIG. 1).

For example, in an electric vehicle, a hybrid vehicle, or the like, a sound with strong randomness due to road noise or aerodynamic noise is dominant in the noise in the vehicle compartment 2.

On the other hand, disturbance sounds such as a sound of the wind of an air conditioner provided in the vehicle 1 and a sound of the wind entering the vehicle compartment 2 due to the window being opened also have strong randomness.

Even in such a case, the disturbance determination part 130 is required to determine whether a disturbance is present by separating the sound of the disturbance from the noise in the vehicle compartment 2.

In view of this, the disturbance determination part 130 obtains correlation functions (Vc1 to VcN) between the reference signals r1 to rN and the error signal e. Further, the disturbance determination part 130 calculates the overall correlation (Vcall: also referred to as a correlation value) by summing the obtained correlation functions (Ve1 to VcN).

The disturbance determination part 130 is configured to determine whether a disturbance is present based on the overall correlation.

As illustrated in FIG. 4, when there are noise control devices 100a, 100b, . . . respectively provided for a plurality of error microphones 13a, 13b, . . . , whether a disturbance is present may be determined for each of the error microphone signals of the noise control devices 100a, 100b, . . . Therefore, it is possible to identify a noise control device (error microphone) in which a disturbance is mixed to stop the output of the noise control device appropriately.

The disturbance determination part 130 determines whether a disturbance is present based on the overall correlation from the error signal e generated by each of the error microphones 13a, 13b, . . . In this determination, the value of the correlation of at least any one pair of reference signals among the reference signals r1 to rN can be used as a common correlation value. In this way, when the disturbance is detected using the error signal e generated by each of the error microphones 13a, 13b, . . . , the amount of calculation can be reduced by calculating the correlation of the reference signals using the common value.

The calculation of the cross-correlation function uses a convolution operation of two signals as follows.

First, a description will be given of a calculation method (A), which is one of the calculation methods to be performed by the disturbance determination part 130. In the calculation method (A), the disturbance determination part 130 calculates a cross-correlation function (Vci (t)) between each of the reference signals r1, r2,., rN and the error signal e using the following Formula (1).

$$V {c}_{i} ( t ) = {\sum }_{t = n - M + 1}^{n} {r}_{i} ( t + τ ) \cdot e ( t ) \qquad ( 1 )$$

where t is a discrete time, n is a current time, M is the size of a signal buffer, and t is a time difference.

The time difference τ is set in advance as a control parameter taking into account the transmission time of the noise d into the vehicle compartment 2.

Next, the disturbance determination part 130 sums the absolute values of the correlation functions (Vc1 to VcN) between the reference signals r1 to rN and the error signal e, obtained by Formula (1), as in the following Formula (2) to calculate the overall correlation value Vcall(t).

$$V {c}_{all} ( t ) = {\sum }_{i = 1}^{N} \vert {Vc}_{i} ( t ) \vert \qquad ( 2 )$$

With this, the disturbance determination part 130 obtains the overall correlation value Vcall used for determining whether a disturbance is present.

Next, a description will be given of a calculation method (B) performed by the disturbance determination part 130. In the calculation method (A), when there is a correlation between the reference signals, the overall correlation value Vcall may overestimate the correlation between the reference signals r and the error signal e.

Taking this into account, the disturbance determination part 130 obtains a correlation value Vcrij of at least a pair of reference signals among the input plurality of reference signals r1 to rN. Then, the disturbance determination part 130 performs an operation of removing the obtained reference signal correlation value Vcrij from the overall correlations. With this, the overall correlation value is obtained so as not to be excessive.

In the calculation method (B), a calculation is performed using Formula (3) to remove sums of at least one pair of correlation values Vcrij(t) of the reference signals from the overall correlation value Vcall(t) obtained by Formula (2).

$$Vc ( t ) = {Vc}_{all} ( t ) - {Σ}_{j , j \neq i} \vert {\sum }_{t = n - M + 1}^{n} {r}_{i} ( t + τ ) \cdot {r}_{j} ( r + τ ) \vert \qquad ( 3 )$$

Here, as the same time difference t is set for two signals, t=0 can be set.

For example, when the same vibration input is transmitted from the four wheels of the vehicle 1 to the vehicle body, it is conceivable that a noise d due to the vibration would be generated in the vehicle compartment 2.

For example, when vibrations are applied to the left and right wheels in the same up-down (z) direction, the reference signals r1,r2 or r3,r4 of the paired acceleration sensors 14a, 14b or 14c, 14d have a correlation of 1 with the noise d in the vehicle compartment 2 (when the cross-correlation is normalized).

At this time, the correlation between the paired reference signals r, for example, of the left and right paired wheel acceleration sensors 14a, 14b or 14c, 14d, also becomes 1.

Taking this into account, the disturbance determination part 130 calculates the correlation value Vc(t) as in the following Formula (4).

$$V c ( t ) = V {c}_{a l l} ( t ) - ( V c {r}_{12} ( t ) + V c {r}_{13} ( t ) + V c {r}_{14} ( t ) ) = 4 - 3 = 1 \qquad ( 4 )$$

Therefore, it is understood that the reference signals r and the error signal e are completely correlated as expected.

Therefore, even when the correlation values Vcrij(t) of the reference signals are removed from the overall correlation value Vcall(t) to use the resultant value as the correlation value Vcall for the determination, the disturbance can be effectively determined without a large difference.

Next, a description will be given of a calculation method (C). The calculation method (C) can reduce the amount of calculation as compared with the calculation method (B).

In the calculation method (C), the disturbance determination part 130 calculates cross-correlation functions Vci(t) between each of the reference signals r1, r2, . . . , rN and the error signal e using the following Formula (5).

$$V {c}_{i} ( t ) = {\sum }_{t = n - M + 1}^{r ι} {r}_{i} ( t + τ ) \cdot e ( t ) \qquad ( 5 )$$

Here, in the disturbance determination part 130, specific channel number(s) of the reference signal for calculating the correlation is specified as a control parameter. For example, the channel number(s) of at least one of the reference signals r1, r2, . . . , rN having a high correlation with the error signal e representing the room sound may be set in advance.

Next, the disturbance determination part 130 sums the results obtained by Formula (5) as in the following Formula (6) to calculate a correlation value Vcall(t) indicating the overall correlation as a numerical value.

$$V {c}_{a l l} ( r ) = {\sum }_{i} \vert {Vc}_{i} ( t ) \vert \qquad ( 6 )$$

With this, the calculation method (C) may configured to omit the calculation of subtracting the correlations between the reference signals from the overall correlation value obtained by summing the results. Even in this case, there is no change in the tendency of the correlation value decreasing due to the mixing of the disturbance. Therefore, the disturbance determination part 130 is capable of making a valid determination using the overall correlation value Vcall calculated according to Formula (6).

Information indicative of whether a disturbance is present, determined by the disturbance determination part 130, is sent to the control operation setting part 140.

The disturbance determination part 130 sets the operation of each of the control filters 10-1 to 10-N based on the information indicative of whether a disturbance is present.

As illustrated in FIG. 2, in the noise control device 100 of the first embodiment, the plurality of error microphones 13a to 13d are disposed in a distributed manner in the headrests (see FIG. 2) which are paired on the left and right sides in the front and rear seats in the vehicle compartment 2.

The disturbance determination part 130 calculates the correlation with respect to each of the error signals e transmitted from the error microphones 13a and 13d by using the calculation methods (A) to (C). The disturbance determination part 130 calculates the overall correlation value by summing the correlation functions between the error signal e and the plurality of input reference signals r1 to rN.

Then, the disturbance determination part 130 determines whether a disturbance is present based on the obtained overall correlation value.

When the disturbance determination part 130 calculates the overall correlation by summing the correlation function between the error signal e and each reference signal of reference signals r1 to rN, the disturbance determination part 130 may set the correlation function to −1 if the reference signal and the error signal e have the same sign.

This simplifies the calculation to be performed by the disturbance determination part 130 to calculate the overall correlation value Vcall by summing the correlation function between each of the input plurality of reference signals r1 to rN and the error signal e. Therefore, when such calculation is performed, it is possible for the disturbance determination part 130 to obtain the overall correlation value Vcall with a small amount of calculation.

The noise control device 100 of the first embodiment configured as described above is capable of accurately determining whether a disturbance is mixed even when periodic noise components are small and further preventing the noise from being amplified due to disturbance-originated divergence of the control, thereby to reduce the noise more stably.

Specifically, the plurality of reference signals r1 to rN are input to the respective noise controllers 110. When any one of the reference signals r1 to rN includes components originated from a disturbance, the correlation values (Vc1 to VcN) of the correlation functions between the reference signals r1 to rN and the respective error signals e1 to eN decrease.

Then, the obtained correlation functions are summed to calculate the overall correlation value Vcall. In this event, the overall correlation value Vcall obtained by summing the plurality of correlation values is remarkably decreased when a disturbance is mixed.

The first filters 111 are capable of, according to the adaptively updated filter characteristics W1 to WN, generating the control signal u for controlling the output of a corresponding one of the speakers 12a to 12d based on such a overall correlation value Vcall.

Thus, when the first filters 111 output the generated control signal u to a corresponding one of the speakers 12a to 12d, the corresponding one of the speakers 12a to 12d generates a cancellation sound y corresponding to the control signal u thereby to reduce the noise d in the vehicle compartment 2 effectively.

In the noise control device 100 of the first embodiment, the disturbance determination part 130 receives the reference signals r1 to rN transmitted from the acceleration sensors 14a to 14d and the error signals e transmitted from the error microphones 13a to 13d. The disturbance determination part 130, for each of the error signals e, obtains the correlation values (Vc1 to VcN) by the correlation function between each of the plurality of input reference signals r1 to rN and the error signal e. Further, the disturbance determination part 130 calculates the overall correlation value Vcall by summing the obtained correlation values (Vc1 to VcN). Then, the disturbance determination part 130 determines whether a disturbance is present based on the overall correlation value Vcall.

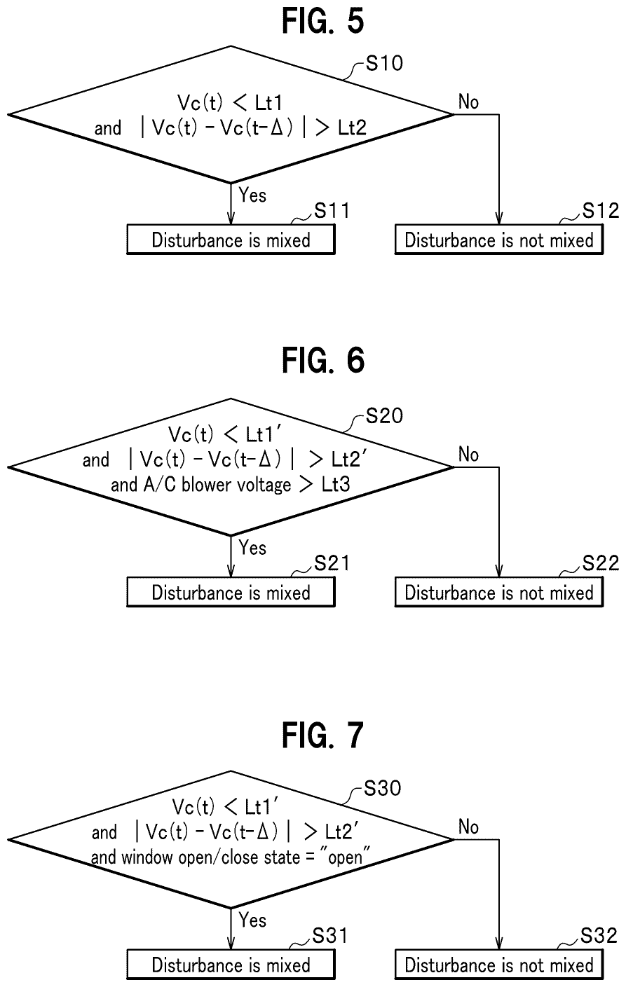

In the flowchart of the disturbance determination illustrated in FIG. 5, in step S10, when the value Vc(t) based on the overall correlation is smaller than a first threshold Lt1 set in advance and the difference Vc(t)-Vc(t-Δ) based on the overall correlations is larger than a second threshold Lt2 set in advance (Yes in step S10), the disturbance determination part 130 proceeds to step S11 to determine that mixing of a disturbance is occurring.

Here, Lt1 is a first threshold set for the cross-correlation value in advance. Lt2 is a second threshold which is set in advance and indicates a pace of an increase or decrease of the cross-correlation value. t represents a discrete time, and A represents a time interval. The second threshold Lt2 may be a threshold indicating a pace of the decrease of the cross-correlation value.

In step S10, when at least one of the following conditions is satisfied (No in step S12): the value Vc(t) based on the overall correlation values is not smaller than the first threshold Lt1 set in advance; or the difference Vc(t)-Vc(t-Δ) based on the overall correlations is not larger than the second threshold Lt2 set in advance, the disturbance determination part 130 proceeds to step S12 to determine that no mixing of disturbance is occurring.

As described above, the flowchart of the disturbance determination illustrated in FIG. 5 determines that mixing of disturbance is occurring when the overall correlation value is smaller than the first threshold Lt1 set in advance and the overall correlation value increases or decreases at a pace greater than the second threshold Lt2 set in advance.

With this, even when the base periodic noise components are small so that the amount of decrease in the correlation is originally small, such as in a case of an electric vehicle or a hybrid vehicle, it is possible to determine whether a disturbance is being mixed more accurately by using the rapid change in the correlation in the determination.

The noise control device 100 of the first embodiment uses the reference signals r1 to rN generated by the acceleration sensors 14a to 14d. The reference signals r1 to rN are signals of vehicle body vibrations and therefore do not include components that act as disturbance factors, such as a sound of the wind from the air conditioner or a sound of the wind entering the vehicle compartment 2 due to a window being opened.

Therefore, the disturbance determination part 130 is capable of accurately determining whether disturbance is mixed in the microphone signals by using the correlation between the reference signals r1 to rN in which disturbance due to wind is unlikely to be mixed and the microphone signal in which disturbance due to wind is likely to be mixed.

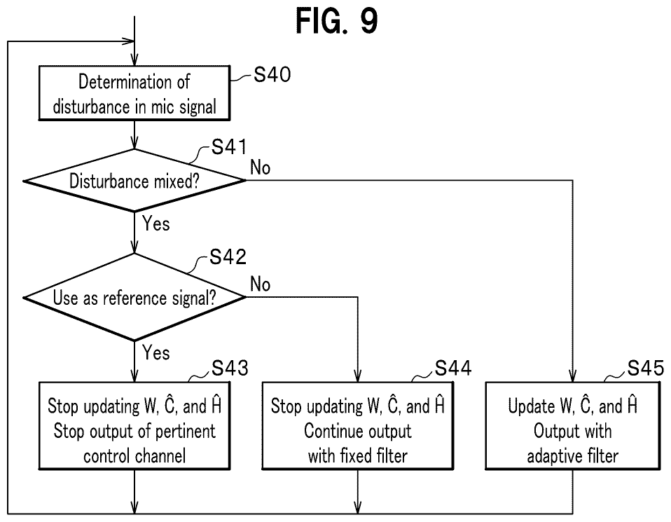

The determination results in the flows of step S11 and step S12 as to whether mixing of disturbance is occurring may be used, in step S40 of the flowchart illustrating the filter control of the second embodiment illustrated in FIG. 9, together with an additional microphone signal usable as a reference signal or alone to determine whether the disturbance is mixed.

FIGS. 6 to 7, described below, illustrate examples of cases where a determination is made in the first embodiment as to whether a disturbance is present. The results of the determination may be used for control of the control filters 10-1 to 10-N in the second embodiment illustrated in FIG. 9.

In the flowchart of disturbance determination illustrated in FIG. 6, a condition regarding the air volume of an air conditioner is used for the determination as to whether a disturbance is mixed (whether a disturbance is present) in addition to the conditions used in the flowchart illustrated in FIG. 5.

Specifically, when the condition for determining that a disturbance is being mixed, indicated in the flowchart illustrated in FIG. 5, is satisfied and the value of the air volume of the air conditioner, based on an air conditioner blower voltage, is larger than a third threshold Lt3 set in advance, the disturbance determination part 130 determines that mixing of disturbance is occurring.

More in detail, in step S20, when the correlation value Vc(t) based on the overall correlation is smaller than a first threshold Lt1′ set in advance, the correlation value difference Vc(t)-Vc(t-Δ) based on the overall correlations is larger than a second threshold Lt2′ set in advance, and the air conditioner is operating with an air conditioner blower voltage larger than the third threshold Lt3 set in advance (Yes in step S20), the disturbance determination part 130 proceeds to step S21 to determine that mixing of disturbance is occurring.

Even when the correlation value Vc(t) is smaller than the first threshold Lt1 set in advance and the correlation value difference Vc(t)-Vc(t-Δ) based on the overall correlations is larger than the second threshold Lt2 set in advance, if the air conditioner blower voltage is not larger than the third threshold Lt3 set in advance, the disturbance determination part 130 determines that the air conditioner is not operating (No in step S20) and proceeds to step S22 to determine that no mixing of disturbance is occurring.

The determination results in the flows of step S21 and step S22 as to whether mixing of disturbance is occurring are used, in step S40 of the flowchart illustrating the filter control of the second embodiment illustrated in FIG. 9, together with the additional microphone signal usable as an additional reference signal or alone to determine whether a disturbance is being mixed.

Note that as described later, step S20 may be such that when the correlation value Vc(t) based on the overall correlation is smaller than a first threshold Lt1′ set in advance, and the air conditioner is operating with an air conditioner blower voltage larger than the third threshold Lt3 set in advance, the disturbance determination part 130 proceeds to step S21 to determine that mixing of disturbance is occurring and otherwise proceeds to step S22 to determine that no mixing of disturbance is occurring. That is, the condition that the correlation value difference Vc(t)-Vc(t-Δ) based on the overall correlations is larger than a second threshold Lt2′ set in advance may be not necessarily included in the determination condition of step S20.

Furthermore, in the flowchart of the disturbance determination illustrated in FIG. 7, the open/close state of a window is used for the determination as to whether a disturbance is present in addition to the conditions used in the flowchart illustrated in FIG. 5.

Specifically, when the condition of disturbance mixing in the flowchart illustrated in FIG. 5 is satisfied and the open/close state of a window is determined as open based on a window control signal, the disturbance determination part 130 determines that a disturbance is present.

More in detail, in step S30, when the correlation value Vc(t) based on the overall correlation is smaller than a first threshold Lt1′ set in advance, the correlation value difference Vc(t)-Vc(t-Δ) based on the overall correlations is larger than a second threshold Lt2′ set in advance, and the open/close state of a window is “open” (Yes in step S30), the disturbance determination part 130 proceeds to step S31 to determine that mixing of disturbance is occurring.

Even when the correlation value Vc(t) is smaller than the first threshold Lt1 set in advance and the correlation value difference Vc(t)-Vc(t-Δ) based on the overall correlations is larger than the second threshold Lt2 set in advance, if the open/close state of a window is “close” (No in step S30) rather than “open”, the disturbance determination part 130 proceeds to step S32 to determine that no mixing of disturbance is occurring.

The determination results in the flows of step S31 and step S32 as to whether mixing of disturbance is occurring are used, in step S40 of the flowchart illustrating the filter control of the second embodiment illustrated in FIG. 9, together with the additional microphone signal usable as an additional reference signal or alone to determine whether the disturbance is mixed.

Note that as described later, step S30 may be such that when the correlation value Vc(t) based on the overall correlation is smaller than a first threshold Lt1′ set in advance, and the open/close state of a window is “open”, the disturbance determination part 130 proceeds to step S31 to determine that mixing of disturbance is occurring and otherwise proceeds to step S32 to determine that no mixing of disturbance is occurring. That is, the condition that the correlation value difference Vc(t)-Vc(t-Δ) based on the overall correlations is larger than a second threshold Lt2′ set in advance may be not necessarily included in the determination condition of step S30.

In this way, the disturbance determination part 130 is able to determine as to whether a disturbance is present more accurately by obtaining the overall correlation value Vcall and further checking a condition that certainly causes mixing of disturbance.

The control operation setting part 140 of the first embodiment is able to switch the operation of each of the control filters 10-1 to 10-N based on the accurate determination as to whether a disturbance is present by the disturbance determination part 130, so that the first filters 111 stably reduce noise.

### Second Embodiment

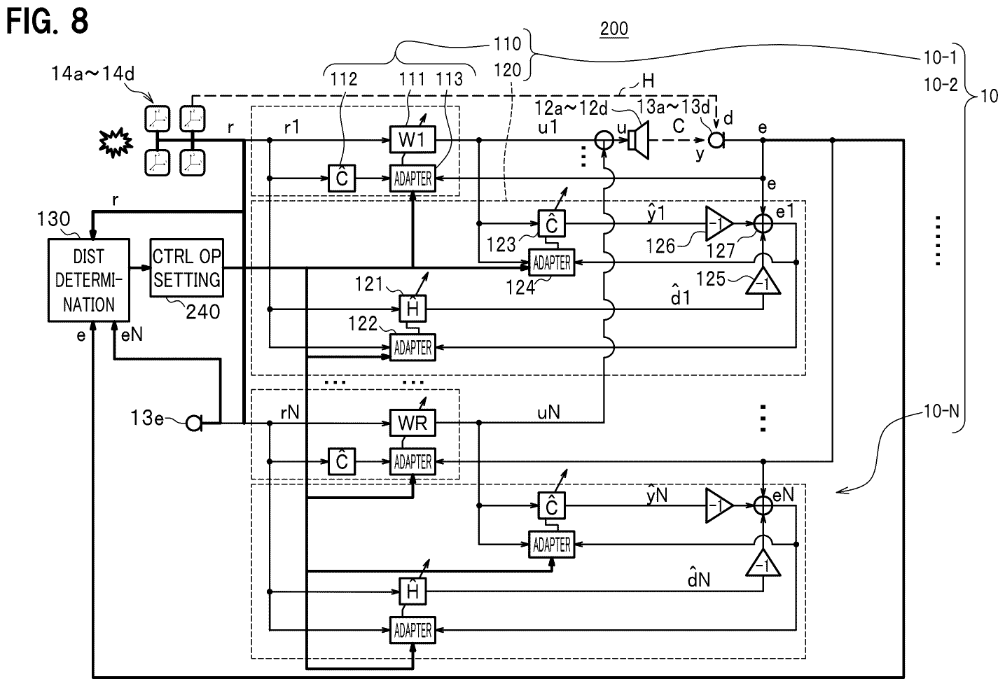

FIG. 8 illustrates an active vibration noise control device (noise control device) 200 according to a second embodiment. The same or equivalent parts as those in the first embodiment are denoted by the same reference signs.

The noise control device 200 includes a reference microphone 13e in addition to the structure of the noise control device 100 of the first embodiment. The reference microphone 13e is located in the same vehicle compartment 2 as the error microphones 13a and 13d.

The reference microphone 13e is connected to the disturbance determination part 130 and to the control filter part 10. The reference microphone 13e transmits a signal generated from a noise in the vehicle compartment 2 to the disturbance determination part 130 and to a respective one of the control filters 10-1 to 10-N.

The control filters 10-1 to 10-N receive, in addition to the reference signals r1 to r12 transmitted from the acceleration sensors 14a to 14d, the signal of the reference microphone 13e as a reference signal rN (N=13) of the reference microphone 13e. Based on these reference signals r1 to rN, the control filters 10-1 to 10-N generate the cancellation sound y.

The control operation setting part 240 of the second embodiment is configured to instruct the control updaters 113 to adaptively update the filter characteristics W, Ĉ, and Ĥ or stop the adaptive update based on the result of determination by the disturbance determination part 130 as to whether a disturbance is present.

FIG. 9 is a flowchart illustrating an example of an operation of reflecting the result of determination as to whether a disturbance is present to the noise control by using the determination result for the control of the control filter part 10.

First, in step S40, a correlation value is calculated by the microphone signal, which is the reference signal rN, or the reference signals r from the acceleration sensor 14a or the like.

Next, in step S41, the disturbance determination part 130 determines whether a disturbance is being mixed. If the determination is that a disturbance is present (Yes in step S41), the process proceeds to step S42. If the determination is that no disturbance is present (No in step S41), the process proceeds to step S45 to update the filter characteristics W, Ĉ, and Ĥ and causes the control updaters 113 to perform outputting for adaptive update.

In step S45, when determination is made such that no disturbance is mixed in any microphone, update is performed on the filter characteristics W, Ĉ, and Ĥ normally while control outputs are generated with the updated values. With this, both the adaptive update of filter characteristics and the control output to control channels are performed using the reference signals in a state where no disturbance component is included.

Specifically, when no disturbance is mixed in any microphone, the control operation setting part 240 causes the control updaters 113 to normally update the filter characteristics W, Ĉ, and Ĥ to generate control output using the updated values.

In this way, when the adaptive update of filter characteristics and the output to control channel are performed, it is possible to generate a cancellation sound y including no disturbance component to reduce the noise d in the vehicle compartment 2 effectively.

Even when a disturbance is present, in step S42, a determination is made as to whether to use the signal of the reference microphone 13e as a reference signal for control. Specifically, a flag indicating whether to use the signal of the reference microphone 13e as a reference signal for control is used as a control parameter set in advance.

If the signal of the reference microphone 13e is not used for control as a reference signal (No in step S42), the process proceeds to step S44. If the signal of the reference microphone 13e is used as a reference signal for control (Yes in step S42), the process proceeds to the next step S43 to stop updating the filter characteristics W, Ĉ, and Ĥ of all the control channels and stop the output of the control channel corresponding to the reference microphone 13e.

First, in step S44, when disturbance is mixed in one or a plurality of microphones, if signal of the microphone with the disturbance is used only as an error signal for filter update, adaptive update of the filter cannot be performed correctly. For this reason, the learning of the filter characteristics W, Ĉ, and Ĥ is stopped.

On the other hand, as there is no disturbance in the reference signals r1 to r12 (reference signals generated from the acceleration sensors 14a to 14d) for generating control outputs, the filter values immediately before the disturbance determination may be switched to fixed filters to continue outputting the cancellation sound.

Specifically, the control operation setting part 240 stops updating the filter characteristics W, Ĉ, and Ĥ and continues output with the fixed filters (or the control filter part 10 with the previous filter characteristic Ŵ). Therefore, in step S44, when a disturbance(s) are mixed in one or more microphones, if signals of the microphones with disturbance is used as only the error signals for updating filters, it is possible to generate outputs using the values of the filter characteristics W, Ô, Ô, and the like immediately before the disturbance determination as fixed filters, even if adaptive update of the filters is stopped.

In step S43, when a disturbance is present in the signal of the reference microphone 13e, it is not possible to correctly control the adaptive update of filter characteristics for all the control channels and the control output of the control channel pertinent to the reference microphone 13e. Therefore, the adaptive update of filter characteristics of all the control channel and the control output of the control channel pertinent to the reference microphone 13e are stopped.

In more detail, step S43 stops updating the filter characteristics W, Ĉ, and Ĥ of control channels corresponding to the reference signals r1 to r13, but continues output through the control channels corresponding to r1 to r12 (the reference signals generated by the acceleration sensors). However, step S43 stops output through the control channel pertinent to the reference signal r13 (the signal generated by the reference microphone 13e).

With this, in a state where the adaptive update of filter characteristics of all the control channels and the control output through the control channel pertinent to the reference microphone 13e cannot be performed correctly due to the disturbance, those processes are not performed, to avoid inaccurate adaptive update and control channel outputs including disturbance components.

In the noise control device 200 of the second embodiment configured as described above, when a disturbance occurs, learning of the filter characteristics W, Ĉ, and Ĥ is stopped. On the other hand, as the reference signals r1 to r12 transmitted from the acceleration sensors 14a to 14d are vibration signals of the vehicle body, disturbance is unlikely to be mixed, and the influence of disturbance is small.

Moreover, the output of the cancellation sound can be continued by the filtering process with the reference signals in which no disturbance is mixed. This makes it possible to prevent the volume of the cancellation sound y from being rapidly increased or decreased due to an extreme change in control. Therefore, the noise control device 200 of the second embodiment can further reduce noise stably and improve the quality of noise control.

Other configurations and effects are the same as those of the first embodiment, and thus the description thereof will be omitted.

As has been described above, an active vibration noise control device according to an embodiment of the present invention includes: speakers 12a-12d each for outputting a cancellation sound y for canceling a noise; error microphones 13a to 13d each for generating an error signal e from the noise d and the cancellation sounds y; a plurality of first filters 111 provided for each of the error microphones 13a-13d and configured to generate the cancellation sound y from a plurality of reference signals r1 to rN corresponding to the noise d; and a disturbance determination part 130 configured to determine whether a disturbance is present using the error signals e and the plurality of reference signals r1 to rN.

The disturbance determination part 130 is configured to calculate, for each of the error signals e, an overall correlation value Vcall by summing correlation functions (Ve1 to VcN) between the plurality of reference signals r1 to rN and the error signal e and determine whether a disturbance is present based on the overall correlation value Vcall.

The active vibration noise control device configured as described above is capable of accurately determining whether mixing of a disturbance is occurring even when periodic noise components are small and further preventing the noise from being amplified due to disturbance-originated divergence of the control, thereby to reduce the noise more stably.

More in detail, when the input plurality of reference signals r1 to rN include components presenting disturbances, the overall correlation value Vcall obtained by summing the plurality of correlation functions (Vc1 to VcN) between the reference signals r1 to rN and the error signal e is significantly reduced.

Therefore, the disturbance determination part 130 is capable of accurately determining whether a disturbance is present by obtaining the overall correlation value Vcall.

Moreover, for example, as in the noise control device 100 of the first embodiment, the reference signals r1 to rN corresponding to the noise d are obtained by using a plurality of the acceleration sensors 14a to 14d that detect accelerations in the three axes of xyz directions. The reference signals r1 to rN generated by the acceleration sensors 14a to 14d do not include components of disturbance factors. Therefore, it is possible to determine whether a disturbance is present more accurately. The noise control device 100 of the first embodiment is provided with four triaxial acceleration sensors 14a to 14d, one for each of the front, rear, left, and right wheels. With this, a total of 12 channel reference signals r1 to rN (N=12) are generated to further improve the accuracy of determining whether a disturbance is present.

Moreover, the disturbance determination part 130 may be configured to obtain a correlation values Vcrij of at least one pair of reference signals among the plurality of input reference signals r1 to rN and remove the obtained correlations (correlation values Vcrij) of the reference signals r1, . . . , and the like from the overall correlation value Vcall.

When the reference signals r1, r2, and the like that form a pair are correlated, the overall correlation coefficient (correlation value Vcrij) obtained by summing the correlation functions (Vc1 to VcN) between the reference signals r1 to rN and the error signal is increased. Therefore, by removing the influence of the correlation between the paired reference signals r1, r2, and the like, it is possible to prevent the overall correlation from being overestimated.

For example, in the vehicle 1 of the first embodiment, when vibrations are applied to the left and right wheels in the same vertical (z) direction, the reference signals r1,r2 or r3, r4 of the paired acceleration sensors 14a, 14b or 14c, 14d have a correlation of 1 with the noise signal in the vehicle compartment 2 (when the cross-correlation is normalized).

At this time, the correlation between the paired reference signals r, for example, of the left and right paired wheel acceleration sensors 14a, 14b or 14c,14d, also becomes 1. Therefore, by removing the influence of the correlations of the paired reference signals r1, r2, and the like, the evaluation of the overall correlation value Vcall can be further stabilized.

A plurality of error microphones 13a to 13d are provided, and the disturbance determination part 130 may be configured to determine, for each of the error signals e generated by the error microphones 13a to 13d, whether a disturbance is present based on the overall correlations from the error signal e. The disturbance determination part 130 may be configured to use a correlation value Vcrij of a pair of reference signals among the reference signals r1 to rN as a common correlation value when performing determination with respect to each of the error microphones 13a to 13d.

With this, the disturbance determination part 130 is capable of, when performing the disturbance determination using the error signal e generated by each of the error microphones 13a to 13d, reduce the amount of calculation by calculating the correlations of the reference signals r1 to rN using the common value.

The disturbance determination part 130 may be configured to determine that, when a value based on the overall correlation is smaller than a first threshold Lt1 set in advance and a difference between values based on the overall correlation is larger than a second threshold Lt2 set in advance, a disturbance is present.

That is, the disturbance determination part 130 determines that a disturbance is being mixed in cases where the correlation is not only smaller than the first threshold Lt1 but also is increasing or decreasing at a pace larger than a certain value (second threshold Lt2). With this, even when periodic noise components are small so that the amount of decrease in the base correlation is small, it is possible to detect the disturbance more accurately by using the rapid change in the correlation for the determination.

The disturbance determination part 130 may be configured to use an air conditioner blower voltage for controlling the air volume of an air conditioner for the detection of the disturbance. The disturbance determination part 130 may be configured to determine that a disturbance is occurring when the value based on the overall correlation is smaller than a first threshold Lt1 set in advance and the value of the air volume of the air conditioner obtained from the air conditioner blower voltage is larger than a third threshold Lt3 set in advance.

For example, the disturbance determination part 130 may obtain the value of the air conditioner air volume from the air conditioner blower voltage. Therefore, even when the threshold of the determination condition regarding the correlation is loosely set, misdetection of disturbance can be prevented.

Furthermore, the disturbance determination part 130 may be configured to use for detection of disturbance a window control signal for controlling opening and closing of a window and determine that a disturbance is present when detecting that a value based on the overall correlation is smaller than a first threshold Lt1 set in advance and detecting an open/close state of the window is open based on the window control signal.

By checking whether the window is open in the determination, it is possible to prevent the misdetection of the disturbance even when the threshold of the determination condition regarding the correlation is loosely set.

The active vibration noise control device may include: a control operation setting part 140 configured to set the operation of the control filter part 10 according to the determination by the disturbance determination part 130 as to whether a disturbance is present; and a reference microphone 13e located in the same vehicle compartment 2 as the error microphones 13a to 13d.

The control filter part 10 may be further configured to generate the cancellation sound y using the detection value of the reference microphone 13e as the reference signal r13. The control operation setting part 140 may be configured to, when the disturbance determination part 130 determines that a disturbance is present, stop generating the cancellation sound y using the detection value of the reference microphone 13e.

In this way, when a disturbance is present in the space of the vehicle compartment 2, as it is possible that the detection value of the reference microphone 13e includes the disturbance, the generation of the cancellation sound y is stopped. Therefore, it is possible to prevent the unpleasant cancellation sound y from being output.

In addition, for example, when there is a possibility that the detection value of the reference microphone 13e also includes a disturbance, the detection value of the reference microphone 13e may be used as one of the error signals determined as having no disturbance mixed therein, without being used as the reference signal r13.

The control operation setting part 140 may be configured to, when the disturbance determination part 130 determines that a disturbance is present, stop learning being performed by the control filter part 10, switch the control filter part 10 to a state before stopping the learning or to a fixed filter unrelated to the learning to continue output of the cancellation sound, and cause to control filter part 10 to switch use of reference signals from using the acceleration sensor reference signals and the detection value of the reference microphone to using the acceleration sensor reference signals only.

That is, when the reference microphone 13e is not used, the reference signals r1 to r12 transmitted from the acceleration sensors 14a to 14d are not affected by the disturbance. In view of this, when a disturbance occurs, control operation setting part 140 causes the control filter part 10 to stop the learning and switch the control filter part 10 to a state at the time before the learning is stopped or to fixed filters unrelated to the learning, to continue output of cancellation sound using the reference signals r1 to r12 transmitted from the acceleration sensors 14a to 14d, without using the reference signal r13 of the reference microphone 13e.

This makes it possible to prevent the sound volume from being rapidly increased or decreased due to an extreme change in control. Therefore, the noise reduction effect with further improved noise control quality can be maintained.

Furthermore, in the embodiment, the correlation function representing the correlation is set to 1 when the reference signal and the error signal have the same sign, and the correlation function is set to −1 when the reference signal and the error signal do not have the same sign, and the correlation functions between each of the input plurality of reference signals and the error signal are summed to obtain the overall correlation.

By simplifying the calculation of the overall correlation function in this way, the amount of calculation can be reduced.

Specifically, when the reference signal r and the error signal e have the same sign, the correlation function is set to a predetermined value, for example, 1 in the case of the embodiment. When the reference signal r and the error signal e do not have the same sign, the correlation function is set to a value having the same absolute value as the predetermined value with the opposite sign, for example, −1 in the case of the embodiment. Then, the disturbance determination part 130 obtains an overall correlation function in a simplified manner by summing the correlation function between the error signal e and each of the plurality of input reference signals r. With this, it is possible to determine whether a disturbance is present with a small amount of calculation together with a convolution operation or instead of the convolution operation.

Therefore, the calculation can be simplified to reduce the amount of calculation as compared with a case where the calculation of the overall correlation function is performed only by convolution operations. Therefore, this calculation method is suitable for use in active vibration noise control that requires quick response, such as in the case of a traveling vehicle 1.

As described above, the active vibration noise control device of the present invention exhibits a practically useful operational effect that even when the periodic noise components are small, the mixing of disturbance can be accurately detected to reduce the noise stably.

The present invention is not limited to the above-described embodiment, and various modifications can be made. The above-described embodiments are illustrated for the purpose of describing the present invention in an easily understandable manner, and the present invention is not necessarily limited to the embodiments including all the configurations described above. Furthermore, a part of the configuration of a certain embodiment can be replaced with the configuration of another embodiment, and the configuration of another embodiment can be added to the configuration of a certain embodiment. Furthermore, it is possible to eliminate a part of the configuration of each embodiment, or add or replace with another configuration. Possible modifications of the above embodiment are, for example, as follows.

For example, in the first embodiment, as illustrated in FIG. 4, the noise control device may be constituted by only the noise control devices 100a and 100b, which are respectively connected to the speakers 12a and 12b only. That is, the present invention is not limited to a specific number of noise control devices 100, a specific number of speakers 12, and a specific number of error microphones 13.

Furthermore, the disturbance determination part 130 may be configured to determine that a disturbance is present when the value based on the overall correlation is smaller than a first threshold Lt1 set in advance and the value of the air volume of the air conditioner is larger than a third threshold Lt3 set in advance. That is, in step S20 of the flowchart illustrated in FIG. 6, whether the difference between the values based on the overall correlation is larger than the second threshold Lt2 set in advance may be not necessarily used for the determination as to whether a disturbance is present. In addition, in step S30 of the flowchart illustrated in FIG. 7, whether the difference between the values based on the overall correlation is larger than the second threshold Lt2 set in advance may be not necessarily used for the determination as to whether a disturbance is present.

Furthermore, the second embodiment has been described assuming that the results of the determination as to whether a disturbance is present, illustrated in FIGS. 5 to 7 of the first embodiment, are used for the control of the control filter of the second embodiment illustrated in FIG. 9. However, the second embodiment is not limited to this.

For example, the results of the determination as to whether a disturbance is present, illustrated in FIGS. 5 to 7 of the first embodiment, may be used for control of another control filter that does not use the reference microphone 13e.

Furthermore, the second embodiment has been described such that the control filter is to be controlled using mainly the results of determinations, illustrated in FIGS. 5 to 7, as to whether a disturbance is present. However, the second embodiment is not limited to this. For example, a determination result using a determination method other than the method of determining whether a disturbance is present in the first embodiment may be used.

That is, the second embodiment may be any configuration such that the generation of the cancellation sound using the detection value of the reference microphone 13e is stopped when a disturbance determination part with another configuration determines that a disturbance is present.

The disturbance determination part configured to determine whether a disturbance is present using error signals may not necessarily use the reference signals r1 to r12 transmitted from the acceleration sensors 14a to 14d and representing the noise signals to determine whether a disturbance is present as in the first and second embodiments. For example, other than the acceleration sensors 14a to 14d, any sensor capable of generating a reference signal corresponding to noise, example of which include a stroke sensor and a pressure sensor for detecting the behavior of a suspension, may be used.

That is, the disturbance determination part may be configured to determine whether a disturbance is present using the reference signals generated by these sensors and corresponding to the noise, and the number and shape of the components that generate the reference signals and the method of generating the reference signals are not particularly limited.

1. An active vibration noise control device comprising:
a speaker for outputting a cancellation sound for canceling a noise;
an error microphone for generating an error signal from the noise and the cancellation sound;
a control filter configured to generate the cancellation sound based on a plurality of reference signals corresponding to the noise; and
a disturbance determination part configured to make a determination as to whether a disturbance is present using the error signal and the plurality of reference signals,
wherein the disturbance determination part is configured to:
calculate an overall correlation by summing a correlation function between each of the plurality of reference signals and the error signal, and
make the determination as to whether the disturbance is present based on the overall correlation.

2. The active vibration noise control device according to claim 1,
wherein the disturbance determination part is further configured to:
calculate a reference signal correlation between at least a pair of reference signals among the plurality of reference signals, and
reduce the overall correlation by the calculated reference signal correlation.

3. The active vibration noise control device according to claim 2,
wherein the active vibration noise control device comprises a plurality of error microphones, including the error microphone, each for generating an error signal from the noise and the cancellation sound,
wherein the disturbance determination part is configured to, for each of the plurality of error microphones, calculate an overall correlation by summing a correlation function between each of the plurality of reference signals and the error signal of the error microphone to make a determination as to whether a disturbance is present, and
wherein the disturbance determination part is configured to use the value of correlation between the pair of reference signals among the plurality of reference signals as a common value in the determination for each of the plurality of error microphones.

4. The active vibration noise control device according to claim 1,
wherein the disturbance determination part is further configured to determine that the disturbance is present when a value based on the overall correlation is smaller than a first threshold set in advance and a difference between values based on the overall correlation is larger than a second threshold set in advance.

5. The active vibration noise control device according to claim 1,
wherein the disturbance determination part is further configured to:
obtain a value of an air volume of an air conditioner based on a value of an air conditioner blower voltage for controlling the air volume, and
determine that the disturbance is occurring when a value based on the overall correlation is smaller than a first threshold set in advance and the value of the air volume is larger than a third threshold set in advance.

6. The active vibration noise control device according to claim 1,
wherein the disturbance determination part is further configured to:
detect an open/close state of a window based on a window control signal for controlling opening and closing of a window, and
determine that the disturbance is present when a value based on the overall correlation is smaller than a first threshold set in advance and the detected open/close state of the window is open.

7. The active vibration noise control device according to claim 1, further comprising a control operation setting part configured to set an operation of the control filter based on a result of the determination by the disturbance determination part as to whether the disturbance is present; and
a reference microphone located in a same vehicle compartment as the error microphone,
wherein the control filter is further configured to be capable of generating the cancellation sound using a detection value of the reference microphone as one of the plurality of reference signals, and
wherein the control operation setting part is further configured to, when the result of determination by the disturbance determination part is that the disturbance is present, stop using the detection value of the reference microphone for generating the cancellation sound.

8. The active vibration noise control device according to claim 7,
wherein the control operation setting part is further configured to, when the result of determination by the disturbance determination part is that the disturbance is present:
cause the control filter stop learning;
switch the control filter to a state before stopping the learning or to a fixed filter unrelated to the learning, to continue output of the cancellation sound.

9. An active vibration noise control device comprising:
a speaker for outputting a cancellation sound for canceling a noise;
an error microphone for generating an error signal from the noise and the cancellation sound;
a control filter configured to generate the cancellation sound based on a plurality of reference signals corresponding to the noise; and
a disturbance determination part configured to make a determination as to whether a disturbance is present using the error signal and the plurality of reference signals,
wherein the disturbance determination part is configured to:
calculate, for each of the plurality of reference signals, a correlation function between the reference signal and the error signal as a first predetermined numerical value when the reference signal and the error signal have a same sign and as a second predetermined value when the reference signal and the error signal have opposite signs, the second predetermined numerical value being a value having a same absolute value and an opposite sign as the first predetermined numerical value;
calculate an overall correlation by summing the correlation function calculated between each of the plurality of reference signals and the error signal; and
make the determination as to whether the disturbance is present based on the overall correlation.
